(19) United States
(12) Patent Application Publication
(10) Pub. No.: US 2013/0261879 A1
(43) Pub. Date: Oct. 3, 2013

(54) Method and System for Diagnosing Breakdown Cause of Vehicle and Computer Readable Storage Medium Storing the Method

(71) Applicants: Shi-Huang Chen, Kaohsiung City (TW); Jhing-Fa Wang, Tainan City (TW); Tzyh-Jong Shang, New Taipei City (TW)

(72) Inventors: Shi-Huang Chen, Kaohsiung City (TW); Jhing-Fa Wang, Tainan City (TW); Tzyh-Jong Shang, New Taipei City (TW)

(73) Assignee: Institute for Information Industry, Taipei (TW)

(21) Appl. No.: 13/476,518

(22) Filed: May 21, 2012

(30) Foreign Application Priority Data
Apr. 3, 2012 (TW) 101111847

(51) Int. Cl. G06F 7/00

(52) U.S. Cl. 701/31.8

(57) ABSTRACT

A method for diagnosing breakdown cause of a vehicle is disclosed. In the method, several sound signals are sensed respectively with several sound sensing devices, which are respectively installed at several zones among the vehicle, from the vehicle. A current driving status of the vehicle is obtained through an electrical control unit (ECU) of the vehicle. Determine a sound source of the vehicle according to the sound signals. A breakdown cause of the vehicle is diagnosed according to the sound signals, the current driving status and the sound source.

### RELATED APPLICATIONS

This application claims priority to Taiwan Application Serial Number 101111847, filed Apr. 3, 2012, which is herein incorporated by reference.

### BACKGROUND

1. Technical Field

The present invention relates to a method and system for diagnosing breakdown cause of a vehicle and a computer readable storage medium for storing the method. More particularly, the present invention relates to a method and system for diagnosing breakdown cause of a vehicle according to sound signals sensed by several sound sensing devices and a computer readable storage medium for storing the method.

2. Description of Related Art

Nowadays, vehicles are installed with engines, gearboxes, electrical systems, chassis, etc. Breakdown at engines, gearboxes, electrical systems can be diagnosed utilizing computer systems, whereas no diagnosing method for chassis is provided.

In general, chassis of a vehicle includes tires, shock absorbers, and a suspension architecture, which correspond to each other. When a chassis of a vehicle have a breakdown, abnormal noises may be generated from the bottom part of the vehicle during driving, which leads that such breakdown is hard to be diagnosed directly.

In the prior arts, a breakdown of a vehicle chassis is checked with eyes or pull components of the vehicle chassis in a static mode. As vehicle technology develops, traditional diagnosing methods can not check breakdown at adjustable shock absorbers, suspensions with multiple connecting rods, automatic body-balancing device, etc.

Moreover, since vehicles nowadays can provide good soundproof and music may be played loudly in vehicles, it is hard for drivers to discover abnormal noises from chassis of vehicles. As a result, chassis components have been badly damaged when drivers find such chassis abnormality.

### SUMMARY

According to one embodiment of this invention, a method for diagnosing breakdown cause of a vehicle is disclosed to diagnose breakdown cause of a vehicle according to sound signals sensed from several zones of the vehicle and a current driving status obtained from an electrical control unit (ECU) of the vehicle. The method includes the following steps:
(a) Several sound signals are sensed respectively with several sound sensing devices, which are respectively installed at several zones among the vehicle, from the vehicle.
(b) A current driving status of the vehicle is obtained through an ECU of the vehicle.
(c) Determine a sound source of the vehicle according to the sound signals.
(d) A breakdown cause of the vehicle is diagnosed according to the sound signals, the current driving status and the sound source.

According to another embodiment of this invention, a computer readable storage medium is disclosed to store a computer program for executing a method for diagnosing breakdown cause of a vehicle. Steps of the method are as disclosed above.

According to still another embodiment of this invention, a system for diagnosing breakdown cause of a vehicle is disclosed to diagnose breakdown cause of a vehicle according to sound signals sensed from several zones of the vehicle and a current driving status obtained from an ECU of the vehicle. The system includes several sound sensing devices and a processing unit. The processing unit builds connections with the sound sensing devices. The sound sensing devices are respectively installed at several zones among the vehicle. The processing unit includes a sound receiving module, a status obtaining module, a sound source determining module and a breakdown diagnosing module. The sound receiving module receives several sound signals, which are sensed respectively with the sound sensing devices at the zones. The status obtaining module obtains a current driving status of the vehicle through an ECU of the vehicle. The sound source determining module determines a sound source of the vehicle according to the sound signals. The breakdown diagnosing module diagnoses a breakdown cause of the vehicle according to the sound signals, the current driving status and the sound source.

The present invention can achieve many advantages. Users can fix the vehicle according to the output breakdown cause. In addition, the present invention can be utilized during the daily driving for vehicle breakdown diagnosing. Even if the breakdown cause comes from the chassis of the vehicle, which is not easy to be aware, the breakdown cause may be diagnosed before components of the vehicles totally break down and generate loud noise applying the method of the present application.

These and other features, aspects, and advantages of the present invention will become better understood with reference to the following description and appended claims. It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference made to the accompanying drawings as follows:

FIG. 1 is a flow diagram of a method for diagnosing breakdown cause of a vehicle according to one embodiment of this invention;

FIG. 2 is a diagram of an example that several sound sensing devices are respectively installed at several zones among a vehicle; and

FIG. 3 illustrates a block diagram of a system for diagnosing breakdown cause of a vehicle according to an embodiment of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

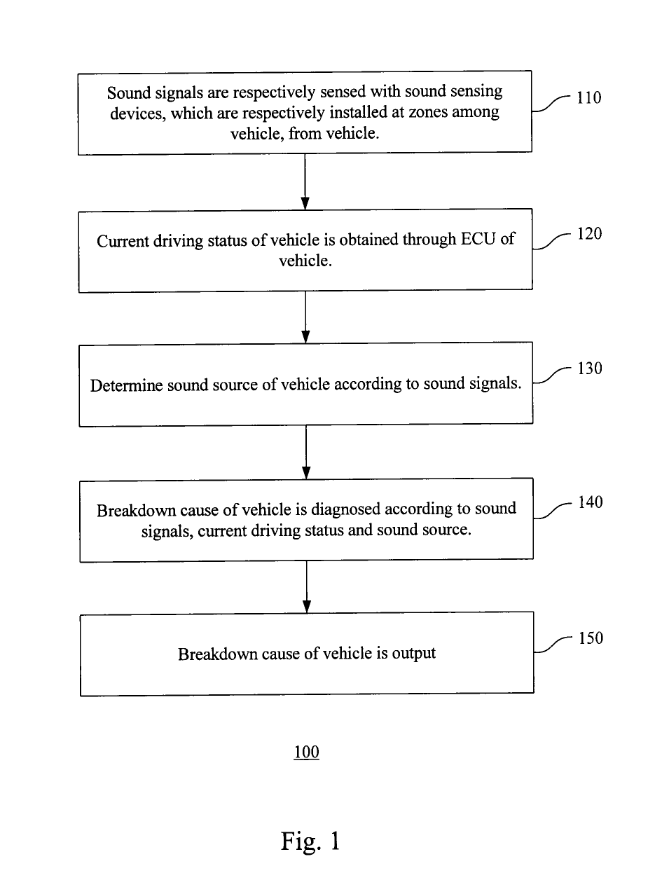

Referring to FIG. 1, a flow diagram will be described that illustrates a method for diagnosing breakdown cause of a vehicle according to one embodiment of this invention. In the method, breakdown cause of a vehicle is diagnosed according to sound signals sensed from several zones of the vehicle and a current driving status obtained from an electrical control unit (ECU) of the vehicle. The method may take the form of a computer program product stored on a computer-readable storage medium having computer-readable instructions embodied in the medium. Any suitable storage medium may be used including non-volatile memory such as read only memory (ROM), programmable read only memory (PROM), erasable programmable read only memory (EPROM), and electrically erasable programmable read only memory (EEPROM) devices; volatile memory such as static random access memory (SRAM), dynamic random access memory (DRAM), and double data rate random access memory (DDR-RAM); optical storage devices such as compact disc read only memories (CD-ROMs) and digital versatile disc read only memories (DVD-ROMs); and magnetic storage devices such as hard disk drives (HDD) and floppy disk drives.

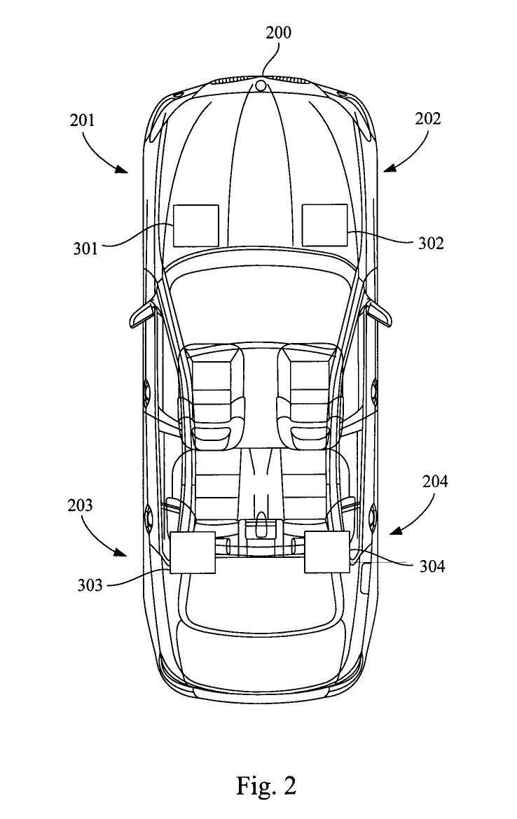

The method 100 for diagnosing breakdown cause of a vehicle starts from step 110, where several sound signals are sensed respectively with several sound sensing devices, which are respectively installed at several zones among the vehicle, from the vehicle. Referring to FIG. 2, a diagram shows an example that several sound sensing devices are respectively installed at several zones among a vehicle. In this embodiment, the vehicle 200 includes several tires 201, 202, 203, 204. The sound sensing devices 301, 302, 303, 304 are respectively installed at the zones neighboring to one of the tires 201, 202, 203, 204. In other embodiments of this invention, the number of the sound sensing devices or the positions for installing the sound sensing devices may differ, which should not be limited by the present disclosure.

The method 100 continues from step 110 to step 120, where a current driving status of the vehicle is obtained through an ECU of the vehicle. In some embodiments, Controller Area Network Bus (CAN Bus) or any other communication protocol may be utilized to build a connection with the ECU of the vehicle to obtain the current driving status of the vehicle (step 120). The obtained current driving status of the vehicle may include a current speed of the vehicle, a current brake status of the vehicle, a current turning angle of a steering wheel of the vehicle or any other information about the current driving status of the vehicle.

The method 100 continues to step 130 to determine a sound source of the vehicle according to the sound signals. In one embodiment of step 130, the zone, the sound sensing device installed at which senses the sound signal with the largest amplitude, is regarded as a sound source of the vehicle. In another embodiment of step 130, the sound signals sensed by the sound sensing devices may be analyzed to determine a sound source of the vehicle.

At step 140, a breakdown cause of the vehicle is diagnosed according to the sound signals, the current driving status and the sound source.

Hence, the method 100 may continue from step 140 to step 150, where the breakdown cause of the vehicle can be output. In some embodiments of this invention, the breakdown cause of the vehicle can be shown on a display unit (for example, a screen) in the form of characters or figures. In some other embodiments of this invention, a speaker may generate speech sounds or sound codes corresponding to the breakdown cause of the vehicle. In other embodiments of this invention, other output methods can be utilized to output the breakdown cause of the vehicle, which should not be limited in this disclosure. Therefore, users can fix the vehicle according to the output breakdown cause. In addition, the method for diagnosing breakdown cause of a vehicle of the present invention can be utilized during the daily driving. Even if the breakdown cause comes from the chassis of the vehicle, which is not easy to be aware, the breakdown cause may be diagnosed before components of the vehicles totally break down and generate loud noise applying the method of the present application.

In one embodiment of step 140, a frequency and an amplitude of an abnormal noise generated from the vehicle may be analyzed according to the sound signals sensed by the sound sensing devices. When the frequency and the amplitude of the abnormal noise changes with the current speed, a category of the abnormal noise generated from the vehicle may be further analyzed.

In some embodiments, when the category of the abnormal noise is determined as a rolling noise, it is determined that a tire-wear abnormality occurs around the sound source of the vehicle. For example, if the sound source of the vehicle comes from right-front zone of the vehicle and the abnormal noise is determined as a rolling noise, it can be determined that wear of the right-front tire of the vehicle is abnormal.

In some other embodiments, when the category of the abnormal noise is determined as a bearing noise, it is determined that a bearing-wear abnormality occurs around the sound source of the vehicle. For instance, if the sound source of the vehicle comes from right-front zone of the vehicle and the abnormal noise is determined as a bearing noise, it can be determined that wear of a bearing installed at the right-front zone of the vehicle is abnormal.

In still another embodiment of this invention, when the frequency and the amplitude of the abnormal noise changes with the current turning angle of the steering wheel and the current speed, it is determined that a gap of a suspension arm of the vehicle around the sound source of the vehicle is abnormal (for example, too large). For example, when the frequency and the amplitude of the abnormal noise changes with the current turning angle of the steering wheel and the current speed and the sound source of the vehicle comes from right-front zone of the vehicle, it can be determined that a gap of a suspension arm installed at the right-front zone of the vehicle is too large.

In another embodiment of step 140, when an abnormal noise is detected among the sound signals during the current brake status in operation, it is determined that a breakdown is occurred at a shock absorber around the sound source of the vehicle. For example, when the vehicle brakes with an abnormal noise generated and the sound source of such noise comes from right-front zone of the vehicle, it is determined that a shock absorber installed at the right-front zone of the vehicle is abnormal.

In still another embodiment of step 140, when the sound source of the vehicle is a tailpipe of the vehicle and it is determined that the sound signals include a tailpipe-hanger abnormality noise, it is determined that a rubber for a tailpipe hanger of the vehicle has a breakdown or a gap of the tailpipe hanger is abnormal.

In practical, the sound signals may be transformed into different kinds of characteristic values for analyzing the frequency and the amplitude of the abnormal noise generated from the vehicle at step 140. For example, the sound signals sensed by the sound sensing devices can be divided into several short-time frames, which are sequentially overlapped, for transforming into characteristic values, such as frequency features or time-frequency features, for representing the characteristics of the frequency and the amplitude of the abnormal noise. In some embodiments, Fourier Transform can be utilized to transform the sound signals sensed by the sound sensing devices into a frequency feature, such as Mel-Scale Frequency Cepstral Coefficients, Pitch Frequency, Sound Spectrum Centroid, Sound Spectrum Spread or other types of frequency features. In some other embodiments, Wavelet Transform can be utilized to transform the sound signals sensed by the sound sensing devices into a time-frequency feature, such as Sound Spectrum Flatness, Subband Energy, Temporal Centroid or other types of time-frequency features. In subsequence, according to characteristic values (for example, frequency features or time-frequency features) for representing an abnormal noise, the current driving status and the sound source of the vehicle, Hidden Markov Model (HMM), Viterbi Algorithm or other algorithms for classification can be utilized to determine a category of the abnormal noise generated from the vehicle. In some embodiments, different abnormal noise models for different breakdown cause can be trained in advance for classification algorithms to determine a category of the abnormal noise.

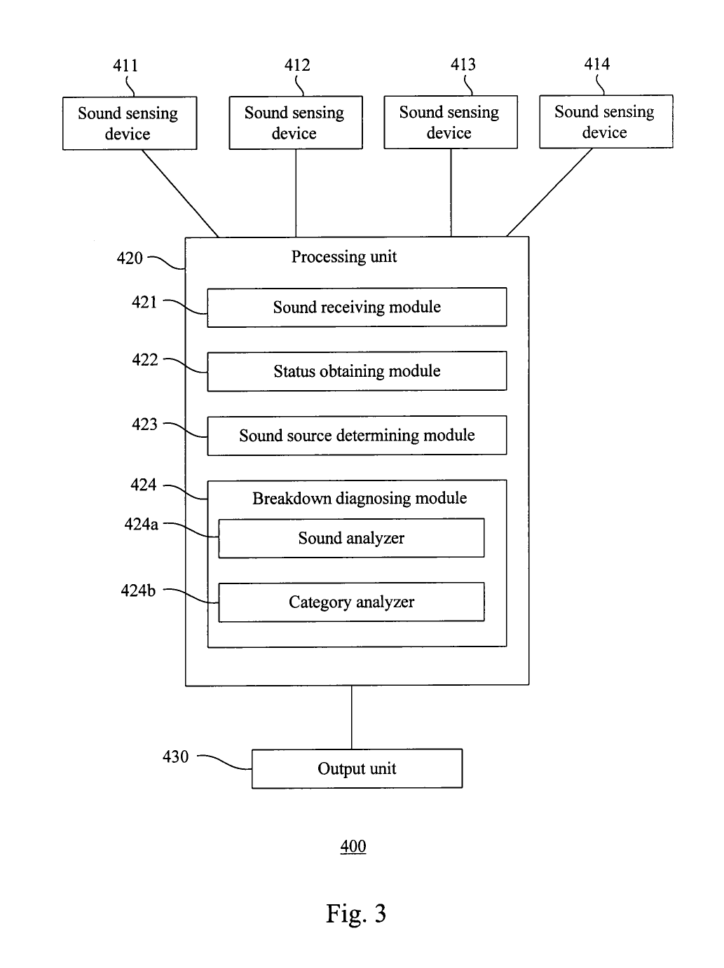

FIG. 3 illustrates a block diagram of a system for diagnosing breakdown cause of a vehicle according to an embodiment of this invention. The system diagnoses breakdown cause of a vehicle according to sound signals sensed from several zones of the vehicle and a current driving status obtained from an ECU of the vehicle.

The system 400 includes several sound sensing devices 411, 412, 413, 414 and a processing unit 420. The processing unit 420 builds connections with the sound sensing devices 411, 412, 413, 414 through a wired or wireless communication method. The sound sensing devices 411, 412, 413, 414 may be speakers or other devices to sense and generate sound signals. The sound sensing devices 411, 412, 413, 414 are respectively installed at several zones among the vehicle. For example, the sound sensing devices 411, 412, 413, 414 can be respectively installed at the zones neighboring to one of the tires of the vehicles. In other embodiments, the number of the sound sensing devices or the positions for installing the sound sensing devices may differ, which should not be limited by the present disclosure.

The processing unit 420 includes a sound receiving module 421, a status obtaining module 422, a sound source determining module 423 and a breakdown diagnosing module 424. The sound receiving module 421 receives several sound signals, which are sensed respectively with the sound sensing devices 411, 412, 413, 414 at their corresponding zones.

The status obtaining module 422 obtains a current driving status of the vehicle through an ECU of the vehicle. The processing unit 420 may build a connection with the ECU of the vehicle through CAN Bus or any other bus applying any other communication protocol, such that the status obtaining module 422 can obtain the current driving status through which.

The sound source determining module 423 determines a sound source of the vehicle according to the sound signals sensed by the sound sensing devices 411, 412, 413, 414. In one embodiment of this invention, the sound source determining module 423 may regard the zone, the sound sensing device installed at which senses the sound signal with the largest amplitude, as a sound source of the vehicle. In another embodiment of this invention, the sound source determining module 423 may analyze the sound signals sensed by the sound sensing devices 411, 412, 413, 414 to determine a sound source of the vehicle.

The breakdown diagnosing module 424 diagnoses a breakdown cause of the vehicle according to the sound signals, the current driving status and the sound source. Moreover, the system 400 may further include an output unit 430, which is electrically connected to the processing unit 420. Subsequently, the output unit 430 may output the breakdown cause. In one embodiment of this invention, the output unit 430 may be a display unit to show the breakdown cause of the vehicle in the form of characters or figures. In another embodiment of this invention, the output unit 430 may be a speaker to generate speech sounds or sound codes corresponding to the breakdown cause of the vehicle. In other embodiments, the output unit 430 may be other types of output units, which should not be limited in this disclosure. Therefore, users can fix the vehicle according to the output breakdown cause. In addition, the system 400 can diagnose during the daily driving. Even if the breakdown cause comes from the chassis of the vehicle, which is not easy to be aware, the system 400 can diagnose the breakdown cause before components of the vehicles totally break down and generate loud noise applying the method of the present application.

In some embodiments of this invention, the breakdown diagnosing module 424 may include a sound analyzer 424a and a category analyzer 424b. The sound analyzer 424a analyzes a frequency and an amplitude of an abnormal noise generated from the vehicle according to the sound signals sensed by the sound sensing devices 411, 412, 413, 414. In practical, the sound analyzer 424a may transform the sound signals sensed by the sound sensing devices 411, 412, 413, 414 into different kinds of characteristic values for analyzing the frequency and the amplitude of the abnormal noise generated from the vehicle. For example, the sound analyzer 424a may divide the sound signals sensed by the sound sensing devices 411, 412, 413, 414 into several short-time frames, which are sequentially overlapped, for transforming into characteristic values, such as frequency features or time-frequency features, for representing the characteristics of the frequency and the amplitude of the abnormal noise. In some embodiments, the sound analyzer 424a may utilize Fourier Transform to transform the sound signals sensed by the sound sensing devices 411, 412, 413, 414 into a frequency feature, such as Mel-Scale Frequency Cepstral Coefficients, Pitch Frequency, Sound Spectrum Centroid, Sound Spectrum Spread or other types of frequency features. In some other embodiments, the sound analyzer 424a may utilize Wavelet Transform to transform the sound signals sensed by the sound sensing devices 411, 412, 413, 414 into a time-frequency feature, such as Sound Spectrum Flatness, Subband Energy, Temporal Centroid or other types of time-frequency features.

Hence, the category analyzer 424b can utilize HMM, Viterbi Algorithm or other algorithms for classification to determine a category of the abnormal noise generated from the vehicle for breakdown-cause determination. In some embodiments, different abnormal noise models for different breakdown cause can be trained in advance for the category analyzer 424b to determine a category of the abnormal noise.

In some embodiments, when the category analyzer 424b determines that the category of the abnormal noise is a rolling noise, the breakdown diagnosing module 424 determines that a tire-wear abnormality occurs around the sound source of the vehicle.

In some other embodiments, when the category analyzer 424b determines that the category of the abnormal noise is a bearing noise, the breakdown diagnosing module 424 determines that a bearing-wear abnormality occurs around the sound source of the vehicle.

In still another embodiment, when the frequency and the amplitude of the abnormal noise analyzed by the sound analyzer 424a changes with the current turning angle of the steering wheel and the current speed, the breakdown diagnosing module 424 determines that a gap of a suspension arm of the vehicle around the sound source of the vehicle is abnormal (for example, too large).

In another embodiment, when an abnormal noise is detected among the sound signals during the current brake status in operation, the breakdown diagnosing module 424 determines that a shock absorber installed at the right-front zone of the vehicle is abnormal.

In another embodiment, when the sound source of the vehicle is a tailpipe of the vehicle and the category analyzer 424b determines that the sound signals include a tailpipe-hanger abnormality noise, the breakdown diagnosing module 424 determines that a rubber for a tailpipe hanger of the vehicle has a breakdown or a gap of the tailpipe hanger is abnormal.

The present invention can achieve many advantages. Users can fix the vehicle according to the output breakdown cause. In addition, the present invention can be utilized during the daily driving for vehicle breakdown diagnosing. Even if the breakdown cause comes from the chassis of the vehicle, which is not easy to be aware, the breakdown cause may be diagnosed before components of the vehicles totally break down and generate loud noise applying the method of the present application.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for diagnosing breakdown cause of a vehicle comprising:
(a) sensing a plurality of sound signals respectively with a plurality of sound sensing devices, which are respectively installed at a plurality of zones among the vehicle, from the vehicle;
(b) obtaining a current driving status of the vehicle through an electrical control unit (ECU) of the vehicle;
(c) determining a sound source of the vehicle according to the sound signals; and
(d) diagnosing a breakdown cause of the vehicle according to the sound signals, the current driving status and the sound source.

2. The method of claim 1, wherein the current driving status of the vehicle comprises a current speed of the vehicle, and step (d) comprises:
analyzing a frequency and an amplitude of an abnormal noise generated from the vehicle according to the sound signals;
when the frequency and the amplitude of the abnormal noise changes with the current speed, analyzing a category of the abnormal noise generated from the vehicle; and
when the category of the abnormal noise is determined as a rolling noise, determining that a tire-wear abnormality occurs around the sound source of the vehicle.

3. The method of claim 1, wherein the current driving status of the vehicle comprises a current speed of the vehicle, and step (d) comprises:
analyzing a frequency and an amplitude of an abnormal noise generated from the vehicle according to the sound signals;
when the frequency and the amplitude of the abnormal noise changes with the current speed, analyzing a category of the abnormal noise generated from the vehicle; and
when the category of the abnormal noise is determined as a bearing noise, determining that a bearing-wear abnormality occurs around the sound source of the vehicle.

4. The method of claim 1, wherein the current driving status of the vehicle comprises a current brake status of the vehicle, and step (d) comprises:
when an abnormal noise is detected among the sound signals during the current brake status in operation, determining that a breakdown is occurred at a shock absorber around the sound source of the vehicle.

5. The method of claim 1, wherein the current driving status of the vehicle comprises a current turning angle of a steering wheel of the vehicle and a current speed of the vehicle, and step (d) comprises:
analyzing a frequency and an amplitude of an abnormal noise generated from the vehicle according to the sound signals;
when the frequency and the amplitude of the abnormal noise changes with the current turning angle of the steering wheel and the current speed, determining that a gap of a suspension arm of the vehicle around the sound source of the vehicle is abnormal.

6. The method of claim 1, wherein step (d) comprises:
when the sound source of the vehicle is a tailpipe of the vehicle and it is determined that the sound signals comprise a tailpipe-hanger abnormality noise, determining that a rubber for a tailpipe hanger of the vehicle has a breakdown or a gap of the tailpipe hanger is abnormal.

7. The method of claim 1, wherein the vehicle comprises a plurality of tires, each of the zones is neighboring to one of the tires.

8. The method of claim 1 further comprising:
outputting the breakdown cause.

9. A system for diagnosing breakdown cause of a vehicle comprising:
a plurality of sound sensing devices installed at a plurality of zones among the vehicle; and
a processing unit for building connections with the sound sensing devices, wherein the processing unit comprises:
a sound receiving module for receiving a plurality of sound signals, which are sensed respectively with the sound sensing devices at the zones;
a status obtaining module for obtaining a current driving status of the vehicle through an electrical control unit (ECU) of the vehicle;
a sound source determining module for determining a sound source of the vehicle according to the sound signals; and
a breakdown diagnosing module for diagnosing a breakdown cause of the vehicle according to the sound signals, the current driving status and the sound source.

10. The system of claim 9, wherein the current driving status of the vehicle comprises a current speed of the vehicle, and the breakdown diagnosing module comprises:
a sound analyzer for analyzing a frequency and an amplitude of an abnormal noise generated from the vehicle according to the sound signals; and
a category analyzer for analyzing a category of the abnormal noise generated from the vehicle when the frequency and the amplitude of the abnormal noise changes with the current speed, wherein when the category analyzer determines that the category of the abnormal noise is a rolling noise, the breakdown diagnosing module determines that a tire-wear abnormality occurs around the sound source of the vehicle.

11. The system of claim 9, wherein the current driving status of the vehicle comprises a current speed of the vehicle, and the breakdown diagnosing module comprises:
a sound analyzer for analyzing a frequency and an amplitude of an abnormal noise generated from the vehicle according to the sound signals; and
a category analyzer for analyzing a category of the abnormal noise generated from the vehicle when the frequency and the amplitude of the abnormal noise changes with the current speed, wherein when category analyzer determines that the category of the abnormal noise is a bearing noise, the breakdown diagnosing module determines that a bearing-wear abnormality occurs around the sound source of the vehicle.

12. The system of claim 9, wherein:
the current driving status of the vehicle comprises a current brake status of the vehicle, and
when an abnormal noise is detected among the sound signals during the current brake status in operation, the breakdown diagnosing module determines that determines that a breakdown is occurred at a shock absorber around the sound source of the vehicle.

13. The system of claim 9, wherein the current driving status of the vehicle comprises a current turning angle of a steering wheel of the vehicle and a current speed of the vehicle, and the breakdown diagnosing module comprises:
a sound analyzer for analyzing a frequency and an amplitude of an abnormal noise generated from the vehicle according to the sound signals, wherein when the frequency and the amplitude of the abnormal noise changes with the current turning angle of the steering wheel and the current speed, the breakdown diagnosing module determines that a gap of a suspension arm of the vehicle around the sound source of the vehicle is abnormal.

14. The system of claim 9, wherein when the sound source of the vehicle is a tailpipe of the vehicle and it is determined that the sound signals comprise a tailpipe-hanger abnormality noise, the breakdown diagnosing module determines that a rubber for a tailpipe hanger of the vehicle has a breakdown or a gap of the tailpipe hanger is abnormal.

15. The system of claim 9, wherein the vehicle comprises a plurality of tires, each of the sound sensing devices is installed neighboring to one of the tires.

16. The system of claim 9 further comprising:
an output unit electrically connected to the processing unit, wherein the output unit outputs the breakdown cause.

17. A computer readable storage medium with a computer program to execute a method for diagnosing breakdown cause of a vehicle, wherein the method comprises:
(a) sensing a plurality of sound signals respectively with a plurality of sound sensing devices, which are respectively installed at a plurality of zones among the vehicle, from the vehicle;
(b) obtaining a current driving status of the vehicle through an electrical control unit (ECU) of the vehicle;
(c) determining a sound source of the vehicle according to the sound signals; and
(d) diagnosing a breakdown cause of the vehicle according to the sound signals, the current driving status and the sound source.
